(19) United States
(12) Patent Application Publication
(10) Pub. No.: US 2026/0135145 A1
(43) Pub. Date: May 14, 2026

(54) OXIDE MATERIAL

(71) Applicant: Murata Manufacturing Co., Ltd., Nagaokakyo-shi (JP)

(72) Inventors: Kota OTA, Nagaokakyo-shi (JP); Hiroyuki MORITA, Nagaokakyo-shi (JP); Takayuki KONO, Nagaokakyo-shi (JP); Kazuki YOSHINO, Nagaokakyo-shi (JP); Yasunori HIOKI, Nagaokakyo-shi (JP); Takeshi TORITA, Nagaokakyo-shi (JP)

(21) Appl. No.: 19/443,278

(22) Filed: Jan. 8, 2026

Related U.S. Application Data
(63) Continuation of application No. PCT/JP2024/025126, filed on Jul. 11, 2024.
(60) Provisional application No. 63/512,971, filed on Jul. 11, 2023.

(51) Int. Cl. H01M 10/0562; C01G 23/00

(52) U.S. Cl. CPC H01M 10/0562; C01G 23/00; C01P 2002/72; C01P 2002/77; C01P 2002/82; C01P 2002/90; C01P 2006/40; H01M 2300/008

(57) ABSTRACT

An oxide material comprising: one or more materials selected from the group consisting of a nanofiber, a nanowire, and a two-dimensional substance, and represented by a formula: MQₐO_{b} wherein M is one or more element selected from the group consisting of Groups 3, 4, 5, 6, and 7, Q is one or more element selected from the group consisting of Groups 12, 13, 14, 15, and 16, excluding O, a is 0 to 2, and b is more than 0 and 2 or less; and a metal element and/or metalloid element on a surface and/or between layers of the one or more materials, wherein a total content of halogen elements is 0.90 mass % or less.

### CROSS REFERENCE TO RELATED APPLICATIONS

The present application is a continuation of International application No. PCT/JP2024/025126, filed Jul. 11, 2024, which claims priority to U.S. Provisional Patent Application No. 63/512,971, filed Jul. 11, 2023, the entire contents of each of which are incorporated herein by reference.

### TECHNICAL FIELD

The present disclosure relates to an oxide material.

### BACKGROUND ART

Conventionally, for example, TiO₂ is known as an oxide containing metal. Non-patent Document 1 proposes a method for converting 12 Ti compounds containing harmless precursors (such as TiC and TiN) abundant on earth into TiO₂-based one-dimensional (1D) nanofilaments (NFs). It has also been shown that the TiO₂-based one-dimensional (1D) nanofilaments (NFs) may be applied in the fields of photocatalysts, dye decomposition, batteries, supercapacitors, and the like.
Non-patent Document 1: Hussein O. Badr et al., “On the structure of one-dimensional TiO2 lepidocrocite” Matter 6, 128-141, Jan. 4, 2023

### SUMMARY OF THE DISCLOSURE

The TiO₂-based one-dimensional (1D) nanofilaments (NFs) have an instability that the crystal structure changes when subjected to physical stimuli such as laser beam and heat. If the crystal structure changes, it is considered that an expressed function changes. For example, in the case of TiCO, when a laser beam with a wavelength of 532 nm is applied to increase the light intensity, or alternatively the temperature is raised to 500° C., the Raman spectrum changes, and the crystal structure changes from a lepidocrocite type to an anatase type from the assignment of the spectrum. However, for applications such as an adsorbent, a photocatalyst, and an ion conductor, for example, the crystal structure is preferably of a lepidocrocite type rather than an anatase type because the lepidocrocite type provides a larger effective interlayer and specific surface area, resulting in higher adsorption capacity, catalytic activity, and ionic conductivity. Therefore, there is a demand for an oxide material in which the crystal structure is of the lepidocrocite type, the crystal structure remaining unchanged and retaining the lepidocrocite type even when the laser beam is applied or even when the temperature is raised to 500° C.

The present disclosure has been made in view of the above circumstances, and an object of the present disclosure is to provide an oxide material in which a crystal structure is of a lepidocrocite type, the crystal structure remaining unchanged and retaining the lepidocrocite type even when irradiated with a strong laser beam or heated to a high temperature of 500° C.

According to one gist of the present disclosure, there is provided an oxide material comprising:
one or more materials selected from the group consisting of a nanofiber, a nanowire, and a two-dimensional substance, and represented by a formula:

MQₐO_{b}
wherein M is one or more element selected from the group consisting of Groups 3, 4, 5, 6, and 7,
Q is one or more element selected from the group consisting of Groups 12, 13, 14, 15, and 16, excluding O,
a is 0 to 2, and
b is more than 0 and 2 or less; and
a metal element and/or metalloid element on a surface and/or between layers of the one or more materials,
wherein a total content of halogen elements is 0.90 mass % or less.

According to the present disclosure, there is provided an oxide material in which a crystal structure remains unchanged and retains a lepidocrocite type, for example, even when a laser beam of 532 nm is applied to increase the light intensity or even when the temperature is raised to 500° C.

### BRIEF DESCRIPTION OF THE DRAWINGS

FIG. 1A is a schematic explanatory diagram illustrating a form of a material according to the present embodiment.

FIG. 1B is a schematic explanatory diagram illustrating another form of the material according to the present embodiment.

FIG. 1C is a schematic explanatory diagram illustrating another form of the material according to the present embodiment.

FIG. 2 is an explanatory diagram of a representative atomic model of the material according to the present embodiment.

FIG. 3 is another explanatory diagram of a representative atomic model of the material according to the present embodiment.

FIG. 4 is another explanatory diagram of a representative atomic model of the material according to the present embodiment.

FIG. 5 is an explanatory diagram of a representative atomic model of an anatase-type material.

FIG. 6 is another explanatory diagram of a representative atomic model of the material according to the present embodiment.

FIG. 7 is another explanatory diagram of a representative atomic model of the material according to the present embodiment.

FIG. 8 shows a Raman spectroscopic analysis result of a film after laser irradiation at each light intensity in Example 1.

FIG. 9 shows a Raman spectroscopic analysis result of a film heated to 500° C. in Example 1.

FIG. 10 shows a Raman spectroscopic analysis result of a film heated to 500° C. in Example 2.

FIG. 11 shows a Raman spectroscopic analysis result of a film heated to 500° C. in Comparative Example 1.

FIG. 12 shows a Raman spectroscopic analysis result of a film after laser irradiation at each light intensity in Comparative Example 6.

### DETAILED DESCRIPTION

The present embodiment relates to an oxide material comprising one or more selected from the group consisting of a nanofiber, a nanowire, and a two-dimensional substance, and a metal element and/or metalloid element on a surface and/or interlayer, wherein a total content of halogen elements is 0.90 mass % or less. In the present disclosure, simply referring to the “material” means a “material containing one or more selected from the group consisting of a nanofiber, a nanowire, and a two-dimensional substance” (in other words, a material at least containing one or more selected from the group consisting of a nanofiber, a nanowire, and a two-dimensional substance). Simply referring to the “oxide material” means a compound composed of oxygen and other elements. In the present embodiment, the material containing one or more selected from the group consisting of a nanofiber, a nanowire, and a two-dimensional substance typically means a material that is solid and does not contain a binder or the like (for example, a polymer). The material containing one or more materials selected from the group consisting of a nanofiber, a nanowire, and a two-dimensional substance can mean, in a narrow sense, a material substantially composed of one or more materials selected from the group consisting of a nanofiber, a nanowire, and a two-dimensional substance (which may contain other objects, impurities, or the like that may be inevitably mixed). However, the material containing one or more materials selected from the group consisting of a nanofiber, a nanowire, and a two-dimensional substance is not limited thereto.

The material of the present embodiment is one or more materials selected from the group consisting of a nanofiber, a nanowire, and a two-dimensional substance of a predetermined material (substance). The predetermined material that can be used in the present embodiment is represented by Formula (1) below:

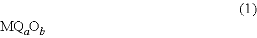

wherein M is one or more element selected from the group consisting of Groups 3, 4, 5, 6, and 7, and may contain a so-called early transition metal, for example, one or more element selected from the group consisting of Sc, Ti, Zr, Hf, V, Nb, Ta, Cr, Mo, and Mn, and preferably one or more element selected from the group consisting of Ti, V, Cr, Mo, and Mn,
Q is one or more element selected from the group consisting of Groups 12, 13, 14, 15, and 16, excluding O, and may contain, for example, one or more element selected from the group consisting of B, C, N, Si, P, and S,
a is 0 to 2, and
b is more than 0 and 2 or less.

Hereinafter, the predetermined material is also simply referred to as “MQO”. Examples of MQO include materials represented by formulas such as TiO₂, TiCO, TiCON, VO₂, VCO, VCON, CrO₂, CrCO, CrCON, MoO₂, MoCO, MoCON, MnO₂, MnCO, and MnCON. For example, in Formula (1), M may be Ti, and the Q may be C. For example, in Formula (1), a may not be 0.

MQO has a crystal structure different from that of a hexagonal system. Although the present embodiment is not bound by any theory, it can be considered that the crystal structure of MQO is an anatase type, a lepidocrocite type, or a mixture thereof at present. As described above, the crystal structure of MQO may be a lepidocrocite type.

MQO can be produced using a first raw material and a second raw material, for example, as follows. The first raw material contains at least M, the second raw material contains at least Q, and the first raw material and the second raw material can react in a protic solvent to generate MQO.

As the first raw material, a material represented by Formula (2) below can be used:

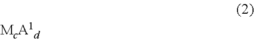

wherein M is as described above,
A¹ is one or more element selected from the group consisting of Groups 12, 13, 14, 15, and 16, and may contain, for example, one or more element selected from the group consisting of B, C, N, O, Si, P, and S, and
c and d are each independently 1 to 5.

However, the material represented by Formula (2) needs to be different from MQO of the product. Typically, the material represented by Formula (2) may not have a peak in a range where a diffraction angle 2θ is 2° to 12° in an X-ray diffraction (XRD) pattern.

Examples of the first raw material represented by Formula (2) include TiB₂, TiB, TiC, TiN, TiO₂, Ti₅Si₃, Ti₂SbP, VO₂, V₂O₄, NbC, Nb₂O₅, MoO₂, MoO₃, MoS₂, MnO₂, Mn₃O₄, and MnCO₃. MnO₂ that can be used as the first raw material has a peak in the vicinity of 2θ=13° and does not have a peak in the range where 2θ is 2° to 12° in the XRD pattern.

Alternatively, or in addition to the above, a material represented by Formula (3) below (hereinafter, also simply referred to as “MAX phase” or “MAX raw material”) can be used as the first raw material:

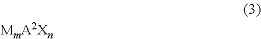

wherein M is as described above,
X is one or more element selected from the group consisting of C and N,
n is 1 to 4,
m is greater than n and 5 or less, and
A² is one or more element selected from the group consisting of Groups 12, 13, 14, 15 and 16, usually a Group A element, typically a Group IIIA and Group IVA, and more particularly may contain one or more selected from the group consisting of Al, Ga, In, Tl, Si, Ge, Sn, Pb, P, As, S and Cd, preferably Al.

The MAX phase has a crystal structure in which a layer constituted by A² atoms is located between two layers represented by MₘXₙ (each X may have a crystal lattice located in an octahedral array of M). Typically, when m=n+1, the MAX phase has a repeating unit in which one layer of X atoms is disposed between each of the n+1 layers of M atoms (these layers being collectively referred to as an “MₘXₙ layer”), and a layer of A² atoms (“A² atomic layer”) is disposed as the layer following the (n+1)th layer of M atoms. However, the MAX phase is not limited thereto.

Examples of the first raw material represented by Formula (3) include Ti₃AlC₂, Ti₃GaC₂, and Ti₃SiC₂.

As the first raw material, the material represented by Formula (2) and the material represented by Formula (3) may be used together (for example, as a mixture).

As the second raw material, an ion-binding substance having a carbon-containing group can be used. The ion-binding substance having a carbon-containing group contains C. Examples of the ion-binding substance include an ammonium salt, a phosphate salt, and a sulfate salt.

More specifically, a quaternary ammonium salt can be used as the second raw material. Examples of the quaternary ammonium salt include tetramethylammonium hydroxide (TMAH), tetraethylammonium hydroxide (TEAH), tetrapropylammonium hydroxide (TPAH), tetrabutylammonium hydroxide (TBAH or TBAOH), benzyltrimethylammonium hydroxide, tetrabutylammonium fluoride (TBAF), tetrabutylammonium chloride (TBACl), tetrabutylammonium bromide (TBAB), tetrabutylammonium iodide (TBAI), benzyltriethylammonium chloride (BTEAC), hexadecyltrimethylammonium bromide, cetyltrimethylammonium bromide (CTAB), benzethonium chloride, benzalkonium chloride, and cetylpyridinium chloride (CPC). Among them, TMAH and TBAOH are preferable.

Alternatively, or in addition to the above, other ion-binding substances containing, for example, P and/or S may be used as the second raw material.

The protic solvent may be any solvent that can at least partially dissolve the first raw material and the second raw material, and may be particularly an aqueous solvent. As the protic solvent, water, an alcohol (for example, ethanol, 1-propanol, or isopropanol), a carboxylic acid (for example, acetic acid or formic acid), or the like is used. The aqueous solvent may be composed of water and optionally a liquid substance compatible with water (for example, a protic solvent other than water), preferably water.

The first raw material and the second raw material are reacted in the protic solvent. The second raw material can be added to the protic solvent in advance. The ratio of the second raw material to the total of the protic solvent and the second raw material may be, for example, 5 mass % or more, particularly 20 mass % or more, and/or may be, for example, 80 mass % or less, particularly 50 mass % or less. The first raw material can be further added to and mixed with the protic solvent to which the second raw material has been added. In such a mixture, a reaction for producing MQO proceeds. The temperature (reaction temperature) of the mixture (which may comprise the reaction product) may be, for example, 15° C. or more, particularly 40° C. or more, and/or may be, for example, 100° C. or less, particularly 80° C. or less. A mixing time (reaction time) may be, for example, 1 day or more, particularly 2 days or more, and/or may be, for example, 10 days or less, particularly 7 days or less. The mixing can be performed, for example, by rotating and stirring a magnetic stirrer bar charged into a container using a magnetic stirrer while the reaction temperature is maintained by a hot plate stirrer and a hot water bath. However, the treatment operation and conditions (temperature, time, and the like) under which the reaction can proceed are not limited to the above, and may be appropriately selected according to the first raw material, the second raw material, the protic solvent, and the like to be used.

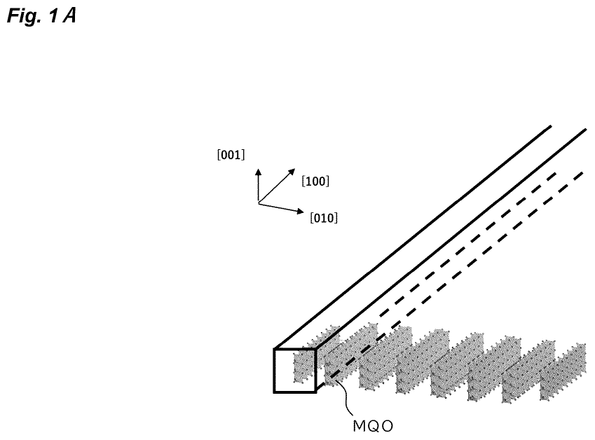

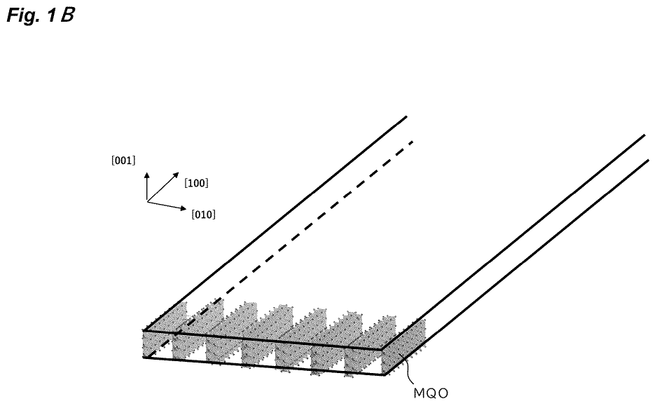

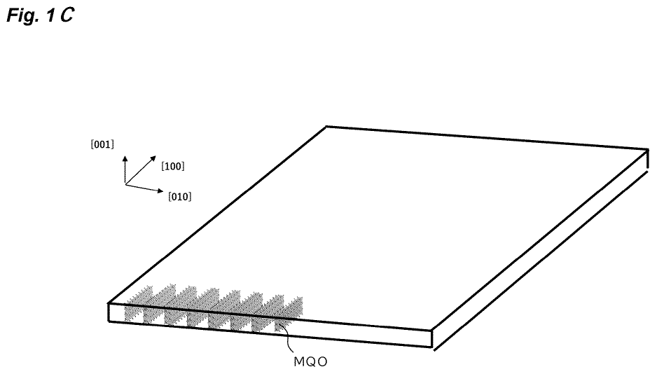

The above reaction generates MQO, which may subsequently grow into nanofibers of MQO and further into nanoflakes of MQO. FIGS. 1A to 1C are each a schematic explanatory diagram illustrating a form of a material according to the present embodiment. Without limiting the present disclosure, the resulting nanofibers of MQO may be in the form of nanoribbons extending (in the [100] direction of FIG. 1A) with a nanoscale width (width in the [001] direction in FIG. 1A), as schematically illustrated in FIG. 1A, for example. A plurality of nanofibers (or nanoribbons) of MQO may be bonded and/or integrated with each other to grow into nanoflakes two-dimensionally extending. A plurality of nanoflakes of MQO may overlap each other (for example, by van der Waals force) to form a laminate, as schematically illustrated in FIG. 1B. In addition, as schematically illustrated in FIG. 1C, the nanoflakes may grow into layered nanoflakes extending two-dimensionally. As a higher order structure, a porous body (for example, a particle shape or a film shape) in which layered nanofibers are entangled with each other, or a layer structure in which layered nanoflakes are laminated in the thickness direction can be obtained. Although the present disclosure is not bound by any theory, such generation and growth of MQO can be considered to be due to a bottom-up type synthesis reaction.

The mixture after the reaction (also referred to as a reaction mixture) may be appropriately subjected to post-treatment. Examples of the post-treatment include washing, impact application (including shear force application), drying (for example, freeze dry or heat dry), and pulverization.

Washing may be performed using a protic solvent. The same description as above may apply to the protic solvent, and the protic solvent may be, for example, water or alcohol. After washing, a separation operation (centrifugation and/or decantation) may be performed. The washing and separation operations may be repeated until the pH of a supernatant after centrifugation is, for example, 8 or less.

Optionally, washing may be performed using an aqueous solution of a metal salt instead of or in addition to the washing. The metal salt may be, for example, a hydroxide of an alkali metal (such as Li, Na, or K), a hydroxide of an alkaline earth metal (such as Mg, Ca, or Sr), typically NaOH, LiOH, KOH, or the like. Specifically, for example, washing may be performed using an aqueous metal salt solution having a molar concentration of 0.01 to 10. After washing, a separation operation (centrifugation and/or decantation) may be performed. Also in this case, washing and separation operations may be repeated as necessary until the pH of the supernatant after centrifugation is, for example, 8 or less.

Optionally, washing may be performed using an aqueous solution of a metal salt instead of or in addition to the washing. The metal salt may be, for example, a sulfate/nitrate of an alkali metal (such as Li, Na, or K), a sulfate/nitrate of an alkaline earth metal (such as Mg, Ca, or Sr), typically Na₂SO₄, Li₂SO₄, KNO₃, or the like. Specifically, for example, washing may be performed using an aqueous metal salt solution having a molar concentration of 0.01 to 10. After washing, a separation operation (centrifugation and/or decantation) may be performed. Also in this case, washing and separation operations may be repeated as necessary until the pH of the supernatant after centrifugation is, for example, 8 or less.

During and/or after washing, an impact such as vibration and/or ultrasound may be applied. This makes it possible to promote dispersion or the like of MQO particles (for example, nanofibers/nanoflakes, and so on.). When the MQO particles are aggregated, they can be crushed. Such an effect is remarkably obtained when an impact is applied during washing using an aqueous solution of a metal salt (it is considered that metal cations derived from the metal salt can enter gaps of the aggregates, which may be then crushed). The impact can be imparted using, for example, any one or more of a hand shaking, an automatic shaker, a mechanical shaker, a vortex mixer, a homogenizer, an ultrasonic bath, and the like.

Since the MQO particles are solid, a separation operation may be performed at any suitable timing to remove unwanted liquid components if present. As a final separation operation, for example, a drying operation, typically freeze drying or heat drying, may be performed. The freeze drying may be performed, for example, by freezing a mixture containing the MQO particles and a liquid component at any suitable temperature (for example, −40° C.), followed by drying under a reduced pressure atmosphere. The heat drying can be performed, for example, by drying a mixture containing the MQO particles and a liquid component at a temperature of 25° C. or more (for example, 200° C. or less) under a normal pressure or a reduced pressure atmosphere. The pulverization is not particularly limited, but can be performed using, for example, a combination of a mortar and a pestle, an IKA mill, or the like. The pulverization may be performed after drying.

As described above, the MQO particles can be obtained as a material containing MQO. According to the present embodiment, as described above, a material containing MQO can be easily produced, and a photocatalyst or the like that is or contains MQO can be realized.

In the present disclosure, the cross-sectional outer dimension of the nanofibers of MQO means the shortest distance passing through the center in the cross section crossing the longitudinal direction of the nanofibers of MQO. The shape of the cross section of the nanofibers of MQO is not particularly limited, but can be approximated, for example, as rectangular (such as a rectangle or square) or elliptical (such as a flattened circle or true circle). When the nanofibers of MQO are in the form of nanoribbons, the shape of the cross section thereof can be approximated by the rectangle, and the cross-sectional outer dimension can correspond to the short side length of the rectangle. When the nanofibers of MQO are in the form of nanofilaments, the shape of the cross section thereof can be approximated by the flattened circle, and the cross-sectional outer dimension can correspond to the short diameter length of the flattened circle.

In the present disclosure, MQO is a solid. MQO can typically be a particle (or powder).

Although MQO is represented by Formula (1), the material containing MQO (typically, MQO particles) does not need to consist of the constituent elements of Formula (1). Although the present disclosure is not limited, the material containing MQO may optionally have one or more selected from the group consisting of a hydroxy group, a chlorine atom, an oxygen atom, a hydrogen atom, and a nitrogen atom as the modification or termination T present on the surface thereof. In addition, the material containing MQO (typically, MQO particles) may have two or more layers, and ions and/or atoms of a metal element and/or metalloid element may be present between the layers. For example, one or more selected from the group consisting of ammonium ions (for example, quaternary ammonium cations) and metal cations (for example, alkali metal ions and alkaline earth metal ions) may be present between these layers.

The particle size of the MQO particles may be, for example, 0.01 nm or more, particularly 0.1 nm or more, and 1 nm or more, and/or may be, for example, less than 1000 nm, particularly 100 nm or less, and 50 nm or less. Such particles may also be referred to as nanoparticles.

The form of the MQO particles is one or more selected from the group consisting of a nanofiber, a nanowire, and a two-dimensional substance. The two-dimensional substance includes one or more of nanoflake and a laminate of nanoflake. In the present embodiment, the two-dimensional substance is not limited to only the nanoflake and the laminate of nanoflake.

The nanofibers may also be referred to as nanowires. In the present disclosure, “nanofiber” means, for example, as illustrated in FIG. 1A, a solid object extending in the longitudinal direction, and an outer dimension (cross-sectional outer dimension) of a cross section perpendicular to the longitudinal direction is on the nano order (that is, 1 nm to less than 1000 nm) or on the sub-nano order smaller than the nano order (less than 1 nm, for example, 0.1 nm to less than 1 nm). The longitudinal length of the nanofiber is not limited to the nano order (that is, 1 nm to less than 1000 nm), and may be in the micron order (1 μm to less than 1000 μm). The cross-sectional outer dimension of the nanofiber may be, for example, 0.1 nm or more, particularly 1 nm or more, and may be, for example, 100 nm or less, particularly 50 nm or less, preferably 15 nm or less.

In the present disclosure, the “two-dimensional substance” means a solid having a two-dimensionally extended surface (also referred to as a plane or a two-dimensional sheet surface) and having a thickness relatively small with respect to a maximum dimension of the surface (which may correspond to an “in-plane dimension” of a particle), for example, as illustrated in FIG. 1C, and having a thickness on the nano order (that is, 1 nm to less than 1000 nm) or on the sub-nano order smaller than the nano order (less than 1 nm, for example, 0.1 nm to less than 1 nm). The in-plane dimension is not limited to the nano order (that is, 1 nm to less than 1000 nm), and may be in the micron order (1 μm to less than 1000 μm). The two-dimensional substance includes one or more of nanoflake and a laminate of nanoflake as described above. The nanoflake may also be referred to as a nanosheet or a two-dimensional (nano) sheet. The thickness of one layer of the nanoflake may be, for example, 0.01 nm or more, particularly 0.8 nm or more, and may be, for example, 20 nm or less, particularly 3 nm or less. The in-plane dimension of the nanoflake may be, for example, 0.1 m or more, particularly 1 m or more, and may be, for example, 200 m or less, particularly 40 m or less. The nanoflake can be constituted by aggregation of nanofibers.

The laminate of nanoflakes may also be referred to as a multilayer MQO. A distance (interlayer distance or void dimension) between two adjacent nanoflakes (or MQO of two adjacent layers) is not particularly limited.

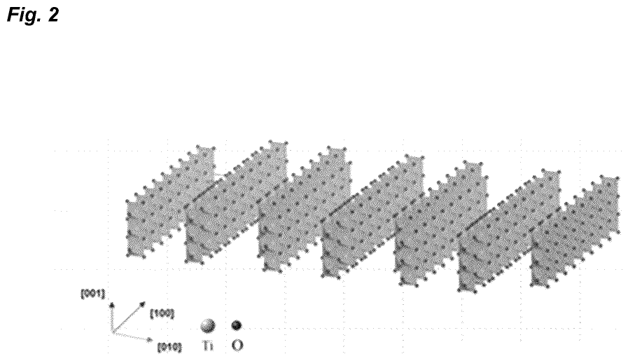

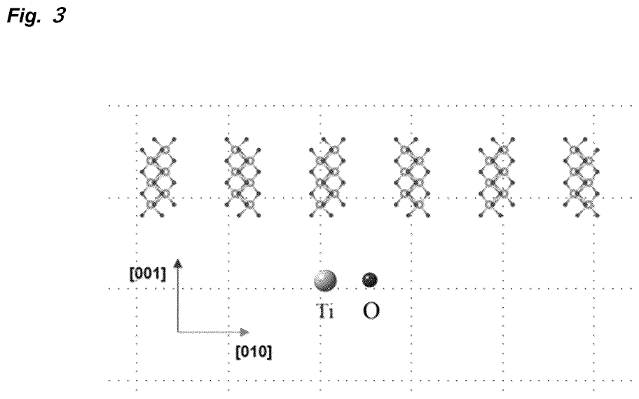

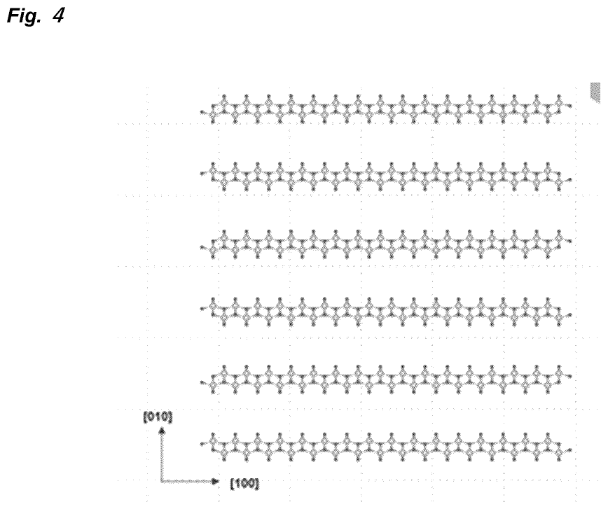

A representative atomic model of the material of the present embodiment (more specifically, MQO) is illustrated along [100], [010], and [001], for example, in FIGS. 2 to 4. These drawings are representative polyhedral diagrams (TiO₂) of TiCO. In the drawings, the number of atoms in each direction is not limited to that shown, and will be described later as a suitable range of the length in each direction. In FIG. 2, TiO₆ octahedra are arranged to form a single layer.

The length in the [100] direction may be from 10 nm to 10 m. In addition, the length in the [100] direction is, for example, preferably from 20 nm to 5 m, and more preferably from 30 nm to 3 m so that handling of the aqueous dispersion becomes easy, that is, the viscosity of the aqueous dispersion falls within an appropriate range.

The length in the [010] direction may be from 1 nm to 5 m. In addition, the length in the [010] direction is, for example, preferably from 3 nm to 1 m, and more preferably from 5 nm to 100 nm so that handling of the aqueous dispersion becomes easy, that is, the viscosity of the aqueous dispersion falls within an appropriate range.

The length in the [001] direction may be from 0.1 nm to 100 nm. In addition, the length in the [001] direction is, for example, preferably from 0.5 nm to 50 nm, and more preferably from 1 nm to 30 nm so that handling of the aqueous dispersion becomes easy, that is, the viscosity of the aqueous dispersion falls within an appropriate range. This range is also preferable because the specific surface area of MQO is increased.

Without limiting the present disclosure, the resulting nanofibers of MQO may be in the form of nanoribbons extending with a nanoscale width as previously described. In addition, the nanofibers may grow into nanoflakes extending two-dimensionally, and for example, the length in the [100] direction and the length in the [010] direction may be about the same (within an error of 20%).

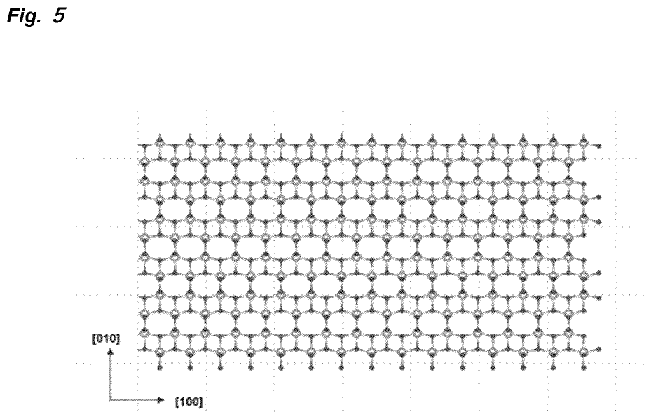

In the present disclosure, the “interlayer” refers to a space between one layer in the [010] direction in FIGS. 1A to 1C and FIGS. 2 to 7 and another adjacent layer (where the space is not formed in FIG. 5). The interlayer distance is from 0.01 nm to 100 nm. If the interlayer distance is too small, the specific surface area decreases, and if the interlayer distance is too large, the interlayer van der Waals force decreases, resulting in decreased structural stability. Therefore, the interlayer distance is preferably from 0.1 nm to 50 nm, and more preferably from 0.3 nm to 20 nm.

Although the present disclosure is not limited, MQO in the present embodiment may have the length in the [010] direction and the length in the [001] direction on the order of nm. This is completely different from the conventional layered material, and the interlayer may be almost exposed to the surface. Therefore, the reaction efficiency can be higher than that of the conventional layered material in physical phenomena such as adsorption and all chemical reactions. Furthermore, when the [100] direction is the longitudinal direction on the order of μm, a one-dimensional material having a layer structure in the [010] direction can be obtained.

The atomic structure of lepidocrocite-type TiO₂ as a representative example of MQO has been described above, but MQO may undergo phase transition to anatase-type TiO₂ due to heat treatment or the like. At that time, as shown in FIG. 5, the interlayer existing in the [010] direction disappears, the specific surface area decreases, and the efficiency of all physical phenomena and chemical reactions may decrease.

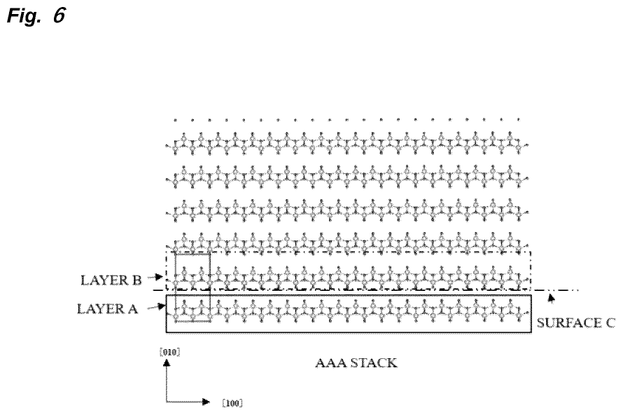

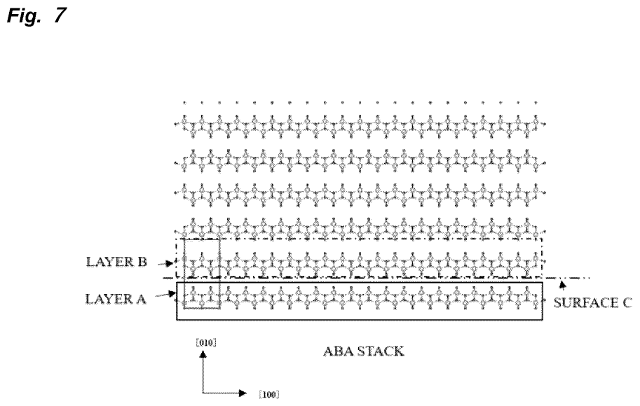

Although the present disclosure is not limited, MQO in the present embodiment may take a different stack state in the [010] direction, for example. For example, when an arbitrary layer A in the [010] direction in FIG. 6 is translated in the [010] direction that is a direction perpendicular to a plane C parallel to a (0k0) plane present in a space (interlayer) between the layer A and another adjacent layer B, the atomic arrangement of the layer A may be in a state of overlapping with the layer B, which is referred to as an AAA stack. At this time, due to the influence of interlayer ions, atomic defects, and the like, minimization of the entire crystal energy is further promoted, and a different atomic arrangement, that is, a crystal structure, may become a stable structure. For example, an ABA stack state in which the atomic arrangement overlaps the layer B when the layer A is reversed with respect to the plane C and then moved in the [010] direction, which is a direction perpendicular to the plane C, is considered. Considering the structural stability of the layered material, the ABA stack illustrated in FIG. 7 is known to be more stable than AAA. Specifically, since the ABA stack structure has specific symmetry, interactions between layers (van der Waals force, electrostatic attractive force, and the like) are uniformized, and regular and efficient atomic arrangement by symmetry is realized. For these reasons, by stabilizing the energy state and the arrangement pattern inside the crystal, energy minimization in the entire crystal structure is promoted, thus enhancing stability. Since the AAA stack structure has a crystal structure contrary to the above, it is relatively sensitive to external factors, thermal energy, and the like, and there is a problem in structural stability. However, since the ABA stack structure is configured as described above, the ABA stack structure has higher resistance to external factors, thermal energy, and the like than the AAA stack structure. Therefore, the layered material in the present embodiment can realize excellent stability and performance by adopting the ABA stack structure.

Each dimension described above can be obtained as a number average dimension (number average of at least 40) based on a photograph observed with a scanning electron microscope (SEM), a transmission electron microscope (TEM), or an atomic force microscope (AFM) (if necessary, processing is performed by a method such as a focused ion beam (FIB)), or a distance in a real space calculated from a position on a reciprocal lattice space of a (002) plane measured by an X-ray diffraction (XRD) method.

However, it should be noted that in the present disclosure, MQO is not limited to the above-described form, and may have any suitable form.

According to the study of the present inventors, in order to obtain the oxide material of the present embodiment, a material containing MQO (one or more selected from the group consisting of a nanofiber, a nanowire, and a two-dimensional substance) is immersed in, for example, an aqueous lithium chloride (LiCl) solution, and then further immersed in an aqueous solution containing, for example, a metal element and/or metalloid element, for example, a hydroxide, a sulfate, a nitrate, or the like of one or more elements among an alkali metal (such as Li, Na, or K) and an alkaline earth metal (such as Mg, Ca, or Sr), typically LiOH, KOH, NaOH, Na₂SO₄, Li₂SO₄, and KNO₃. As a result, it has been found that even when tetramethylammonium (TMA) ions derived from a raw material for production that can be originally contained in a material containing MQO are temporarily substituted with lithium (Li), and further substituted with, for example, an alkali metal element (such as Li, Na, or K) and/or an alkaline earth metal element (such as Mg, Ca, Sr) as a desired metal element and/or metalloid element, and the oxide material is exposed to, for example, intense laser beam irradiation or a high temperature of 500° C., a crystal structure of MQO does not change, a lepidocrocite type is maintained, and a stable crystal structure is obtained according to the present embodiment.

The content of the metal element and/or metalloid element present on the surface and/or interlayer is, for example, preferably from 0.001 to 10 mass %, more preferably from 0.1 to 8 mass %, and still more preferably from 1 to 6 mass %.

As a specific example, according to the studies of the present inventors, it has been found that a material containing MQO (one or more selected from the group consisting of a nanofiber, a nanowire, and a two-dimensional substance) is immersed in an aqueous potassium hydroxide (KOH) solution and then dried, and trimethylammonium (TMA) ions originally contained in the material are substituted with potassium (K), so that the crystal structure of MQO remains unchanged, retains the lepidocrocite type, and exhibits stability even when a laser beam of 532 nm was applied to increase the light intensity, for example.

The oxide material of the present embodiment contains a metal element and/or metalloid element on the surface and/or interlayer. The surface and/or interlayer of the oxide material refers to, for example, a surface and/or interlayer of a material containing MQO (one or more selected from the group consisting of a nanofiber, a nanowire, and a two-dimensional substance).

Examples of the metal element include main group metal elements and transition metal elements of Groups 1 (excluding hydrogen) to 15 of the periodic table, and include one or more of these elements. Examples of the metalloid element include boron, silicon, germanium, arsenic, antimony, and tellurium, and include one or more of these elements. The metal element and/or metalloid element is preferably one or more selected from the group consisting of K, Na, Li, Ca, and Mg.

In the oxide material of the present embodiment, the total content of halogen elements is 0.90 mass % or less. In the present embodiment, it has been found that suppression of the total content of halogen elements thus contained to 0.90 mass % or less enables the crystal structure to retain the lepidocrocite type without transition to the anatase type from the lepidocrocite type, even when irradiated with a strong laser beam or exposed to a high temperature such as 500° C. The halogen elements refer to elements of Group 17 of the periodic table. Examples of the halogen elements particularly include one or more elements selected from the group consisting of Cl, Br, F, I, and At. The total content of these elements may be suppressed to 0.90 mass % or less.

The halogen elements can be contained in the oxide material, and the content thereof is preferably as small as possible, and is preferably 0.50 mass % or less, more preferably 0.20 mass % or less, and most preferably zero. For example, the lower limit of the content of the halogen elements may be 0.001 mass % due to the halogen-containing raw material that can be used in the production process of the oxide material of the present embodiment. The existence position of the halogen elements in the oxide material is not limited. The halogen elements may be included on the surface and/or interlayer of the oxide material. In addition, the halogen elements may interact with ions of the metal element and/or metalloid element.

In the oxide material of the present embodiment, the content of crystal water is 10 mass % or less. In the present specification, the “crystal water” refers to water molecules existing inside the oxide material, particularly, between layers of a material containing MQO. When crystal water is contained, as shown in Examples described later, when the temperature is raised from 50° C. to 500° C. under a He atmosphere (flow rate: 70 mL/min) at a temperature raising rate of 10° C./min, the peak is confirmed as a peak of H₂O gas at a position of 300 to 500° C. The content of crystal water is calculated from the peak. By suppressing the content of the crystal water contained in the oxide material, even when the oxide material is irradiated with a strong laser beam or exposed to a high temperature, the crystal structure does not transition from the lepidocrocite type to the anatase type, and the lepidocrocite type crystal structure can be maintained.

The crystal water may interact with ions and/or atoms of the metal element and/or metalloid element. The content of the crystal water is preferably 5 mass % or less, more preferably 1 mass % or less, and still more preferably 0.5 mass % or less. Note that the content of the crystal water is preferably as small as possible, but the lower limit thereof may be 0.001 mass % due to, for example, a production process, and the content of the crystal water may be in a range of 0.001 to 10 mass %, preferably 0.001 to 1 mass %, and more preferably 0.001 to 0.5 mass %.

The material containing MQO may typically have a peak in a diffraction angle 2θ in a range of 2° to 12° in an X-ray diffraction (XRD) pattern (characteristic X-ray: CuKα=1.54 Å). Although the present disclosure is not bound by any theory, it is considered that the fact that the material containing MQO has a peak in the range of 2θ=2° to 12° in the XRD pattern means that the MQO has a crystal structure different from that of a well-known metal oxide. For example, the above-described peak means that a periodic structure exists in the [0k0] direction. In addition, by having peaks at 2θ=26°, 2θ=48°, and 2θ=63°, it can be confirmed that MQO has a crystal structure of lepidocrocite. Furthermore, supplementary confirmation can also be performed for the identification of ion species between layers by the size of d spacing obtained from the peak in the range of 2θ=2° to 12°.

In the present disclosure, an XRD pattern is a pattern (where the vertical axis represents intensity, and the horizontal axis represents 2θ) obtained by θ-axis direction scanning with an XRD analyzer using CuKα rays (=about 1.54 Å) as characteristic X-rays, and may also be referred to as an “XRD profile”. The peaks in the XRD pattern can be identified visually or using the software used with the XRD analyzer.

Although the present embodiment is not limited, for example, the material of the present embodiment (more specifically, MQO) may have peaks in the Raman spectrum obtained using a laser with a wavelength of 532 nm at Raman shifts of at least 275 to 295 cm⁻¹, 435 to 455 cm⁻¹, and 665 to 745 cm⁻¹.

Although the present embodiment is not limited, for example, the material of the present embodiment (more specifically, MQO) may have peaks in the Raman spectrum obtained using a laser with a wavelength of 532 nm at Raman shifts of 140 to 160 cm⁻¹, 275 to 295 cm⁻¹, 435 to 455 cm⁻¹, and 665 to 745 cm⁻¹. Note that 140 to 160 cm⁻¹ is an anatase type peak.

Although the present embodiment is not limited, for example, the material of the present embodiment (more specifically, MQO) has a crystal structure of an anatase type, a lepidocrocite type, or a mixture thereof. More preferably, it has a lepidocrocite type crystal structure.

Although the present embodiment is not limited, for example, the material of the present embodiment (more specifically, MQO) can take an aspect in which peaks in the Raman spectrum obtained using a laser with a wavelength of 532 nm are observed at Raman shifts of at least 275 to 295 cm⁻¹, 435 to 455 cm⁻¹, and 665 to 745 cm⁻¹, and, when the intensities of the respective peaks are defined as X, Y, and Z, X is the largest.

Although the present embodiment is not limited, more preferably, the material of the present embodiment (more specifically, MQO) can take an aspect in which peaks in the Raman spectrum obtained using a laser with a wavelength of 532 nm are observed at Raman shifts of at least 180 to 200 cm⁻¹, 275 to 295 cm⁻¹, 375 to 395 cm⁻¹, 435 to 455 cm⁻¹, and 665 to 745 cm⁻¹, and, when the intensities of the respective peaks are defined as V, X, Y, Z, and W, X is the largest.

In the present disclosure, the Raman spectrum is measured by a Raman spectrometer using a laser beam having a wavelength of 532 nm as an excitation light source (the vertical axis represents intensity, and the horizontal axis represents Raman shift). The peaks in the Raman spectrum can be identified visually or using the software used with the Raman spectrometer.

In addition, the material containing MQO may contain unreacted first raw material and/or second raw material as impurities, and may contain a substance derived from the first raw material, the second raw material, and/or the protic solvent. For example, when a quaternary ammonium salt is used as the second raw material, N may exist (remain) in any form in the material containing MQO. Although the present embodiment is not limited, the material containing MQO may contain ammonium ions and tetramethylammonium ions. For example, when the MAX raw material is used as the first raw material, in the present disclosure, the material containing MQO may contain a relatively small amount of remaining A atoms, for example, 10 mass % or less with respect to the original A atoms. The residual amount of A atoms may be preferably 8 mass % or less, and more preferably 6 mass % or less. However, even if the residual amount of A atoms exceeds 10 mass %, there may be no problem depending on the use conditions or the like.

In order to obtain a material containing MQO with higher purity, it is preferable to repeat washing and centrifugation multiple times, and to recover the supernatant after final centrifugation. Such a supernatant can be formed into a slurry containing MQO particles as it is, appropriately diluted with a liquid medium, or mixed with a liquid medium after drying.

Although the materials in certain embodiments of the present disclosure have been described in detail above, the present disclosure can be modified in various ways. It should be noted that the material of the present disclosure may be manufactured by a method different from the manufacturing method in the above-described embodiment.

### EXAMPLES

### Example 1

### Preparation of Slurry Containing TiCO

First, a container (100 mL Ai-Boy) was charged with 1 g of titanium diboride (TiB₂, manufactured by Alfa Aesar) and 10 mL of a 25 mass % aqueous tetramethylammonium hydroxide (TMAH) solution (manufactured by Alfa Aesar). To the container was placed a stirrer chip having a length substantially equal to the inner diameter of the circular bottom surface of the container (35 mm). While the container was kept at 80° C. in an oil bath, the mixture in the container was stirred with a stirrer chip and maintained for 120 hours, thereby allowing the reaction to proceed. The reaction mixture in the container was then transferred to a centrifuge tube. Centrifugation was performed using a centrifuge under conditions of 3500 G and 5 minutes to precipitate the solid content. (i) After centrifugation, the supernatant was discarded, (ii) 40 mL of ethanol (manufactured by Fisher Chemical) was added to the remaining precipitate in the centrifuge tube, dispersion treatment using a Vortex mixer was performed for 5 minutes (reslurry), and (iii) centrifugation was performed under the same conditions as described above. The operations (i) to (iii) were repeated until the pH of the supernatant was 8 or less. When the procedure was repeated three times, the pH of the supernatant became 8 or less. Therefore, this supernatant was discarded, and the repeated operation was terminated. Then, 40 mL of pure water was added to the remaining precipitate in the centrifuge tube, and the mixture was shaken and stirred for 5 minutes using a Vortex mixer. Thereafter, centrifugation was performed using a centrifuge under the conditions of 3500 G and 30 minutes, and the supernatant was recovered as a sample slurry. The obtained sample slurry corresponds to a slurry containing TiCO.

### Preparation of TiCO Film

A TiCO film was produced as follows using the slurry containing TiCO. 1 mL of the slurry containing TiCO was collected, mixed with 20 mL of pure water, and then vibrated with a vortex mixer for 5 minutes. The resulting mixture was filtered with suction overnight using a Nutsche filter. As a filter for suction filtration, a membrane filter (Durapore, pore diameter 0.22 m, manufactured by Merck Corporation) was used. After suction filtration, the precursor membrane on the filter was dried overnight at 80° C. in a vacuum oven to remove the filter, thereby obtaining a film (self-supporting membrane).

### Preparation of Aqueous Lithium Chloride (LiCl) Solution-Immersed Film

An aqueous lithium chloride solution having a concentration of 1M was placed in a petri dish, and the film (free-standing film) was immersed therein for 10 minutes. Thereafter, the film was taken out from the aqueous lithium chloride solution, and the film surface was rinsed with pure water for the purpose of removing excessive lithium chloride on the film surface. The washing was repeated until the pH of the washing liquid reached 7. Thereafter, water droplets on the film surface were lightly wiped with a waste cloth to complete an aqueous lithium chloride solution-immersed film.

### Preparation of Aqueous Sodium Hydroxide (NaOH) Solution-Immersed Film

An aqueous sodium hydroxide solution having a concentration of 1 M was placed in a petri dish, and the aqueous lithium chloride solution-immersed film was immersed therein for 10 minutes. Thereafter, the film was taken out from the aqueous sodium hydroxide solution, and the film surface was rinsed with pure water for the purpose of removing excessive sodium hydroxide on the film surface. The washing was repeated until the pH of the washing liquid reached 7. Thereafter, water droplets on the film surface were lightly wiped with a waste cloth to complete an aqueous sodium hydroxide solution-immersed film.

### Tg-Ms Measurement

The aqueous sodium hydroxide solution-immersed film was heated from 50° C. to 500° C. at a heating rate of 10° C./min in a He atmosphere (flow rate: 70 mL/min). The H₂O gas resulting from the crystal water inside the oxide material, for example between the layers of the material comprising MQO, may have a peak at a position of 300 to 500° C. The amount of crystallization water calculated from the peak at the position of 300 to 500° C. was 3.25 wt %.

### IC Measurement

First, 20 mL of pure water was put into 0.01 g of an aqueous sodium hydroxide solution-immersed film, and the film was shaken at 50 to 250 r/min for 60 minutes using a strong shaker (Reciprocal shaker SR-2) manufactured by TAITEC CORPORATION, then centrifuged at 2500 rpm for 10 minutes, and then filtered once using a filtration filter (DISMIC13HP model number: 13HPO20CN manufactured by Advantec). Measurement of each halogen (Cl, Br, F, I, At) in a solution (filtrate) containing ions extracted from the film and obtained by filtration was performed using ion chromatography (IC). As a result, the concentration of each halogen in the aqueous solution was 0.033 wt %.

### Raman Spectroscopic Measurement

In a Raman spectrophotometer (manufactured by HORIBA, product number: LABRAM HR EVO), measurement was performed using a laser beam having a wavelength of 532 nm as an excitation light source to obtain a Raman spectrum of an aqueous sodium hydroxide solution-immersed film. In the Raman spectrum, peaks observed at Raman shifts of 202, 290, 453, 677, and 922 cm⁻¹ suggest that the crystal structure is of the lepidocrocite type. In addition, the presence of a peak at 665 to 745 cm⁻¹ and the fact that the intensity at 735 to 745 cm⁻¹ was larger than the intensity at 745 to 765 cm⁻¹ suggest that the TMA cations and TMAH used for preparing the slurry containing TiCO were removed and substituted with sodium cations and sodium.

(Raman Spectrum Measurement after Laser Irradiation)

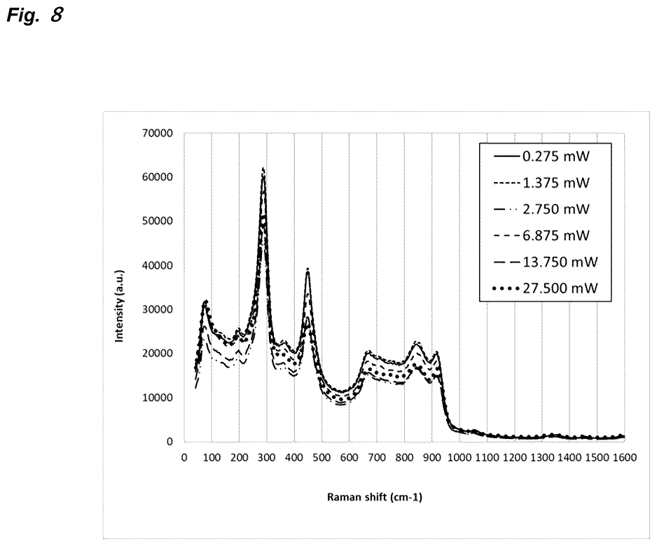

The Raman spectrum of the aqueous sodium hydroxide solution-immersed film was obtained after laser irradiation of the aqueous sodium hydroxide solution-immersed film with a laser intensity changed from 0.275 mW to 27.500 mW. The results are shown in FIG. 8. As shown in FIG. 8, the film according to the present embodiment showed little change in the Raman spectrum even when the laser intensity was increased. Accordingly, it was found that the crystal structure of the TiCO film according to the present embodiment was maintained, and the stability against strong laser beam was high.

(Raman Spectrum Measurement after Heating)

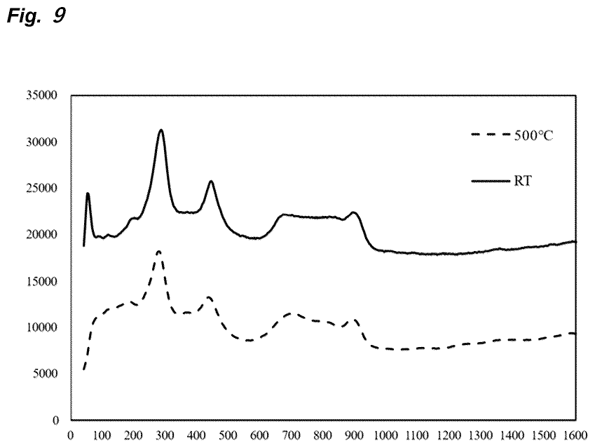

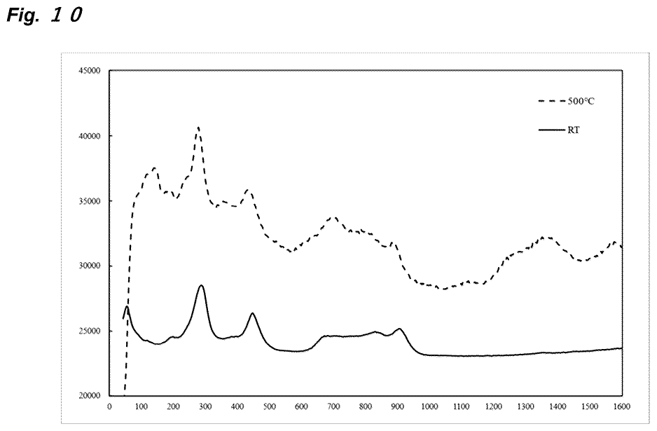

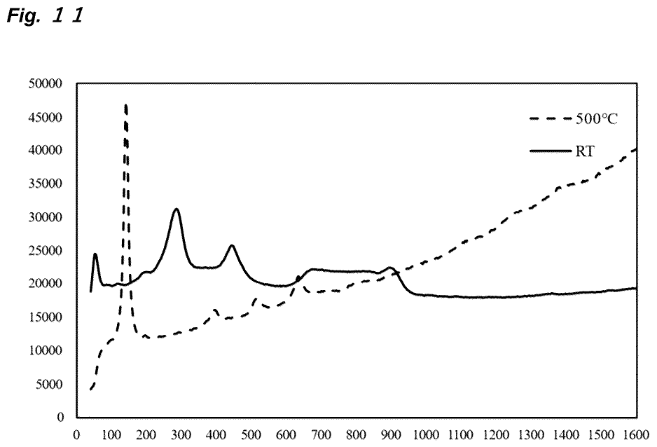

The Raman spectrum of the film after heating the aqueous sodium hydroxide solution-immersed film to 500° C. was acquired. The results are shown in FIG. 9. Note that, in FIG. 9, the horizontal axis represents “Raman shift (cm⁻¹)”, and the vertical axis represents “Intensity (a.u.)” (the same applies to FIGS. 10 and 11 below). As shown in FIG. 9, in the film according to the present embodiment, the Raman spectrum was not much different from that at room temperature (RT) even after heating at 500° C. Accordingly, it was found that the crystal structure of the TiCO film according to the present embodiment was maintained, and the stability against high temperature was high.

### Example 2

First, an aqueous lithium chloride solution-immersed film was prepared in the same manner as in Example 1.

### Preparation of Aqueous Potassium Hydroxide (KOH) Solution-Immersed Film

An aqueous potassium hydroxide solution having a concentration of 1M was placed in a petri dish, and the aqueous lithium chloride solution-immersed film was immersed therein for 10 minutes. Thereafter, the film was taken out from the aqueous potassium hydroxide solution, and the film surface was rinsed with pure water for the purpose of removing excessive potassium hydroxide on the film surface. The washing was repeated until the pH of the washing liquid reached 7. Thereafter, water droplets on the film surface were lightly wiped with a waste cloth to complete an aqueous potassium hydroxide solution-immersed film.

### Tg-Ms Measurement

The aqueous potassium hydroxide solution-immersed film was heated from 50° C. to 500° C. at a heating rate of 10° C./min in a He atmosphere (flow rate: 70 mL/min). As described above, the H₂O gas derived from crystal water may have a peak at a position of 300 to 500° C., but in Example 2, a peak of the H₂O gas present at a position of 300 to 500° C. was not observed.

### IC Measurement

First, 20 mL of pure water was added to 0.01 g of an aqueous potassium hydroxide solution-immersed film, and the film was shaken at 50 to 250 r/min for 60 minutes using a strong shaker (Reciprocal shaker SR-2) manufactured by TAITEC CORPORATION, then centrifuged at 2500 rpm for 10 minutes, and filtered once using a filtration filter (DISMIC13HP model number: 13HPO20CN (Advantec)). The solution (filtrate) after filtration was subjected to measurement of each halogen (Cl, Br, F, I, and At) using ion chromatography (IC). The analysis results showed that each halogen had an aqueous concentration of 0.171 wt %.

### Raman Spectroscopic Measurement

In a Raman spectrophotometer (manufactured by HORIBA, product number: LABRAM HR EVO), measurement was performed using a laser beam having a wavelength of 532 nm as an excitation light source to obtain a Raman spectrum of an aqueous potassium hydroxide solution-immersed film. In the Raman spectrum, peaks observed at Raman shifts of 202, 290, 453, 677, and 922 cm⁻¹ suggest that the crystal structure is of the lepidocrocite type. In addition, the presence of a peak at 665 to 745 cm⁻¹ and the fact that the intensity at 735 to 745 cm⁻¹ was larger than the intensity at 745 to 765 cm⁻¹ suggest that the TMA cations and TMAH used for preparing the slurry containing TiCO were removed and substituted with potassium cations and potassium.

(Raman Spectrum Measurement after Laser Irradiation)

The Raman spectrum of the aqueous potassium hydroxide solution-immersed film was obtained after laser irradiation of the aqueous potassium hydroxide solution-immersed film with a laser intensity changed from 0.275 mW to 27.500 mW. As a result, as in FIG. 8 of Example 1, the film according to the present embodiment had little change in the Raman spectrum even when the laser intensity was increased. Accordingly, it was found that the crystal structure of the TiCO film was maintained, and the stability against strong laser beam was high.

(Raman Spectrum Measurement after Heating)

The Raman spectrum of the film after heating the aqueous potassium hydroxide solution-immersed film to 500° C. was acquired. The results are shown in FIG. 10. As shown in FIG. 10, the film according to the present embodiment showed little change in the Raman spectrum even when the laser intensity was increased. Accordingly, it was found that the crystal structure of the TiCO film was maintained, and the stability against high temperature was high.

### Example 3

### (Ion Conductivity Characteristics)

Using the prepared aqueous potassium hydroxide solution-immersed film (before heating) of Example 1, ion conductivity measurement in the thickness direction was performed as follows assuming a solid electrolyte sample.

A pair of electrodes was disposed on a surface orthogonal to the thickness direction of the film (solid electrolyte sample). A DC or AC voltage was applied between the sample and the pair of electrodes, and an ion current flowing in the sample at that time was measured. The resistance value (impedance) generated in the sample was determined from the relationship between the measured ion current and the applied voltage. The ionic conductivity generated in the sample was calculated from the thickness and area of the sample and the obtained resistance value (impedance). Specifically, a cylindrical sample having a diameter of 10 mm and a thickness of 100 m was prepared as a solid electrolyte sample. A pair of metal disc-shaped electrodes (diameter: 10 mm) was disposed on both end surfaces of the sample, and each electrode was brought into close contact with the sample surface. An AC signal (amplitude: 10 mV) was applied between the pair of electrodes at an AC frequency in the range of 20 Hz to 50 MHz. Then, an AC response signal (impedance) flowing between the pair of electrodes was measured by an impedance analyzer.

The resistance component (R) was determined from the measured impedance data by equivalent circuit analysis.

From the sample thickness (d=100 m), the sample cross-sectional area (A=78.5 mm²), and the obtained resistance component (R), the ionic conductivity (σ) was calculated based on Equation (4) to be 1.1 mS/cm. When the ionic conductivity (σ) was 0.001 mS or more at 30° C. and 95% RH, it was confirmed that an applicable solid electrolyte material was obtained because the solid electrolyte material was useful as a solid electrolyte for a fuel cell and water electrolysis.

$$σ = ( 1 / R ) * ( A / d ) \qquad ( 4 )$$

The solid electrolyte of the fuel cell is expected to operate, for example, at 80 to 100° C. for 2000 hours or more. For example, it is considered that MQO undergoes a phase transition when MQO is used as a solid electrolyte or as an additive operated at the above-described temperature and time. Therefore, as evaluated in Example 1, it is preferable to use MQO according to the present embodiment, which has a stable crystal structure.

### Comparative Example 1

First, a film (free-standing film) was obtained in the same manner as in Example 1.

### Preparation of Aqueous Lithium Chloride (LiCl) Solution-Immersed Film

In order to make the number of immersions the same as Examples 1 and 2, the film (free-standing film) was immersed in an aqueous lithium chloride solution having a concentration of 1 M in the petri dish for 10 minutes, and then the aqueous lithium chloride solution having a concentration of 1 M was put in the petri dish again, and the film (free-standing film) was immersed therein for 10 minutes. Thereafter, the film was taken out from the aqueous lithium chloride solution, and the film surface was rinsed with pure water for the purpose of removing excessive lithium chloride on the film surface. The washing was repeated until the pH of the washing liquid reached 7. Thereafter, water droplets on the film surface were lightly wiped with a waste cloth to complete an aqueous lithium chloride solution-immersed film.

### Tg-Ms Measurement

The aqueous lithium chloride solution-immersed film was heated from 50° C. to 500° C. at a heating rate of 10° C./min in a He atmosphere (flow rate: 70 mL/min). The amount of crystal water calculated from the peak of H₂O gas present at the position of 300 to 500° C. at the time of temperature rise was 2.75 wt %.

### IC Measurement

First, 20 mL of pure water was put into 0.01 g of an aqueous lithium chloride solution-immersed film, and the film was shaken at 50 to 250 r/min for 60 minutes using a strong shaker (Reciprocal shaker SR-2) manufactured by TAITEC CORPORATION, then centrifuged at 2500 rpm for 10 minutes, and filtered once using a filtration filter (DISMIC13HP model number: 13HPO20CN manufactured by Advantec). The measurement of each halogen (Cl, Br, F, I, and At) in the solution (filtrate) after filtration was performed using ion chromatography (IC). As a result, the concentration of each halogen in the aqueous solution was 1.1 wt %.

### Raman Spectroscopic Measurement

Under the same conditions as in Example 1, a Raman spectrum of the aqueous lithium chloride solution-immersed film was acquired. As a result, as in Example 1, peaks were observed in the Raman spectrum at Raman shifts of 198, 286, 453, 684, and 956 cm⁻¹. Accordingly, it is considered that the film produced in Comparative Example 1 also has a lepidocrocite type crystal structure. In addition, the presence of a peak at 665 to 745 cm⁻¹ and the fact that the intensity at 735 to 745 cm⁻¹ was larger than that at 745 to 765 cm⁻¹ suggest that the TMA cations and TMAH used for preparing the slurry containing TiCO were removed and substituted with lithium cations and lithium.

(Raman Spectrum Measurement after Laser Irradiation)

In the same manner as in Example 1, laser irradiation was performed on the aqueous lithium chloride solution-immersed film with the laser intensity changed from 0.275 mW to 27.500 mW, and the Raman spectrum of the aqueous lithium chloride solution-immersed film after laser irradiation at each laser intensity was acquired. As a result, it was found that when the laser intensity was increased, the Raman spectrum was changed at 6.875 mW, and the crystal structure was changed. Specifically, in the Raman spectrum, peaks observed at Raman shifts of 153, 205, 395, 521, and 638 cm⁻¹ suggest that, after the structural change, the crystal structure is of an anatase type. Accordingly, it is presumed that the crystal structure was transferred from the lepidocrocite type to the anatase type when irradiation was performed with the laser intensity increased to 6.875 mW or more.

(Raman Spectrum Measurement after Heating)

The Raman spectrum of the film after heating the aqueous lithium chloride solution-immersed film to 500° C. was acquired. The results are shown in FIG. 11. As can be seen from FIG. 11, when the laser intensity was increased, the film according to Comparative Example 1 had a large change in the Raman spectrum and low stability to high temperatures.

When the amount of halogen contained in the oxide material is large as described above, for example, physical stimuli such as laser beam and heat cause instability that the crystal structure is changed, so that the function to be expressed is changed, and it is considered that the properties of the oxide material cannot be stably exhibited.

### Comparative Example 2

First, an aqueous lithium chloride solution-immersed film was prepared in the same manner as in Example 1.

### Preparation of Aqueous Calcium Chloride (CaCl₂) Solution-Immersed Film

An aqueous calcium chloride solution having a concentration of 1 M was placed in a petri dish, and the aqueous lithium chloride solution-immersed film was immersed therein for 10 minutes. Thereafter, the film was taken out from the aqueous calcium chloride solution, and the film surface was rinsed with pure water for the purpose of removing excessive calcium chloride on the film surface. The washing was repeated until the pH of the washing liquid reached 7. Thereafter, water droplets on the film surface were lightly wiped with a waste cloth to complete an aqueous calcium chloride solution-immersed film.

### Tg-Ms Measurement

The aqueous calcium chloride solution-immersed film was heated from 50° C. to 500° C. at a heating rate of 10° C./min in a He atmosphere (flow rate: 70 mL/min). The amount of crystal water calculated from the peak of H₂O gas present at the position of 300 to 500° C. at the time of temperature rise was 4.36 wt %.

### IC Measurement

First, 20 mL of pure water was put into 0.01 g of an aqueous calcium chloride solution-immersed film, and the film was shaken at 50 to 250 r/min for 60 minutes using a strong shaker (Reciprocal shaker SR-2) manufactured by TAITEC CORPORATION, then centrifuged at 2500 rpm for 10 minutes, and filtered once using a filtration filter (DISMIC13HP model number: 13HPO20CN manufactured by Advantec). The measurement of each halogen (Cl, Br, F, I, and At) in the solution (filtrate) after filtration was performed using ion chromatography (IC). As a result, the concentration of each halogen in the aqueous solution was 1.03 wt %.

### Raman Spectroscopic Measurement

Under the same conditions as in Example 1, a Raman spectrum of the aqueous calcium chloride solution-immersed film was acquired. As a result, as in Example 1, peaks were observed in the Raman spectrum at Raman shifts of 198, 286, 453, 684, and 956 cm⁻¹. Accordingly, it is considered that the film produced in Comparative Example 2 also has a lepidocrocite type crystal structure. In addition, the presence of a peak at 665 to 745 cm⁻¹ and the fact that the intensity at 735 to 745 cm⁻¹ was larger than that at 745 to 765 cm⁻¹ suggest that the TMA cations and TMAH used for preparing the slurry containing TiCO were removed and substituted with calcium cations and calcium.

(Raman Spectrum Measurement after Laser Irradiation)

In the same manner as in Example 1, laser irradiation was performed on the aqueous calcium chloride solution-immersed film with the laser intensity changed from 0.275 mW to 27.500 mW, and the Raman spectrum of the aqueous calcium chloride solution-immersed film after laser irradiation at each laser intensity was acquired. As a result, it was found that when the laser intensity was increased, the Raman spectrum was changed at 6.875 mW, and the crystal structure was changed. In the Raman spectrum, peaks observed at Raman shifts of 153, 205, 395, 521, and 638 cm¹ suggest that, after the structural change, the crystal structure is of an anatase type.

Accordingly, it is presumed that the crystal structure was transferred from the lepidocrocite type to the anatase type when irradiation was performed with the laser intensity increased to 6.875 mW or more. When the amount of halogen contained in the oxide material is large as described above, it is considered that there is instability that the crystal structure is changed by physical stimuli such as laser beam and heat, for example, and the function to be expressed is changed, so that the properties of the oxide material cannot be stably exhibited.

### Comparative Example 3

First, an aqueous lithium chloride solution-immersed film was prepared in the same manner as in Example 1.

### Preparation of Aqueous Magnesium Chloride (MgCl₂) Solution-Immersed Film

An aqueous magnesium chloride solution having a concentration of 1 M was placed in a petri dish, and the aqueous lithium chloride solution-immersed film was immersed therein for 10 minutes. Thereafter, the film was taken out from the aqueous magnesium chloride solution, and the film surface was rinsed with pure water for the purpose of removing excessive magnesium chloride on the film surface. The washing was repeated until the pH of the washing liquid reached 7. Thereafter, water droplets on the film surface were lightly wiped with a waste cloth to complete an aqueous magnesium chloride solution-immersed film.

### Tg-Ms Measurement

The aqueous magnesium chloride solution-immersed film was heated from 50° C. to 500° C. at a heating rate of 10° C./min in a He atmosphere (flow rate: 70 mL/min). The amount of crystal water calculated from the peak of H₂O gas present at the position of 300 to 500° C. at the time of temperature rise was 4.81 wt %.

### IC Measurement

First, 20 mL of pure water was put into 0.01 g of an aqueous magnesium chloride solution-immersed film, and the film was shaken at 50 to 250 r/min for 60 minutes using a strong shaker (Reciprocal shaker SR-2) manufactured by TAITEC CORPORATION, then centrifuged at 2500 rpm for 10 minutes, and filtered once using a filtration filter (DISMIC13HP model number: 13HPO20CN manufactured by Advantec). The measurement of each halogen (Cl, Br, F, I, and At) in the solution (filtrate) after filtration was performed using ion chromatography (IC). As a result, the concentration of each halogen in the aqueous solution was 1.03 wt %.

### Raman Spectroscopic Measurement

Under the same conditions as in Example 1, a Raman spectrum of the aqueous magnesium chloride solution-immersed film was acquired. As a result, as in Example 1, peaks were observed in the Raman spectrum at Raman shifts of 198, 286, 453, 684, and 956 cm⁻¹. Accordingly, it is considered that the film produced in Comparative Example 3 also has a lepidocrocite type crystal structure. In addition, the presence of a peak at 665 to 745 cm⁻¹ and the fact that the intensity at 735 to 745 cm⁻¹ was larger than that at 745 to 765 cm⁻¹ suggest that the TMA cations and TMAH used for preparing the slurry containing TiCO were removed and substituted with magnesium cations and magnesium.

(Raman Spectrum Measurement after Laser Irradiation)

In the same manner as in Example 1, laser irradiation was performed on the aqueous magnesium chloride solution-immersed film with the laser intensity changed from 0.275 mW to 27.500 mW, and the Raman spectrum of the aqueous lithium chloride solution-immersed film after laser irradiation at each laser intensity was acquired. As a result, it was found that when the laser intensity was increased, the Raman spectrum was changed at 6.875 mW, and the crystal structure was changed. In the Raman spectrum, peaks observed at Raman shifts of 153, 205, 395, 521, and 638 cm⁻¹ suggest that, after the structural change, the crystal structure is of an anatase type.

Accordingly, it is presumed that the crystal structure was transferred from the lepidocrocite type to the anatase type when irradiation was performed with the laser intensity increased to 6.875 mW or more. When the amount of halogen contained in the oxide material is large as described above, it is considered that there is instability that the crystal structure is changed by physical stimuli such as laser beam and heat, for example, and the function to be expressed is changed, so that the properties of the oxide material cannot be stably exhibited.

### Comparative Example 4

First, an aqueous lithium chloride solution-immersed film was prepared in the same manner as in Example 1.

### Preparation of Aqueous Potassium Chloride (KCl) Solution-Immersed Film

An aqueous potassium chloride solution having a concentration of 1 M was placed in a petri dish, and an aqueous lithium chloride solution-immersed film was immersed therein for 10 minutes. Thereafter, the film was taken out from the aqueous potassium chloride solution, and the film surface was rinsed with pure water for the purpose of removing excessive potassium chloride on the film surface. The washing was repeated until the pH of the washing liquid reached 7. Thereafter, water droplets on the film surface were lightly wiped with a waste cloth to complete an aqueous potassium chloride solution-immersed film.

### Tg-Ms Measurement

The aqueous potassium chloride solution-immersed film was heated from 50° C. to 500° C. at a heating rate of 10° C./min in a He atmosphere (flow rate: 70 mL/min). A peak of H₂O gas present at a position of 300 to 500° C. at the time of the temperature rise was not detected.

### IC Measurement

First, 20 mL of pure water was put into 0.01 g of an aqueous potassium chloride solution-immersed film, and the film was shaken at 50 to 250 r/min for 60 minutes using a strong shaker (Reciprocal shaker SR-2) manufactured by TAITEC CORPORATION, then centrifuged at 2500 rpm for 10 minutes, and filtered once using a filtration filter (DISMIC13HP model number: 13HPO20CN manufactured by Advantec). The measurement of each halogen (Cl, Br, F, I, and At) in the solution (filtrate) after filtration was performed using ion chromatography (IC). As a result, the concentration of each halogen in the aqueous solution was 1.3 wt %.

### Raman Spectroscopic Measurement

A Raman spectrum was acquired under the same conditions as in Example 1. As a result, as in Example 1, peaks were observed in the Raman spectrum at Raman shifts of 198, 286, 453, 684, and 956 cm⁻¹. Accordingly, it is considered that the film produced in Comparative Example 4 also has a lepidocrocite type crystal structure. In addition, the presence of a peak at 665 to 745 cm⁻¹ and the fact that the intensity at 735 to 745 cm⁻¹ was larger than that at 745 to 765 cm⁻¹ suggest that the TMA cations and TMAH used for preparing the slurry containing TiCO were removed and substituted with potassium cations and potassium.

(Raman Spectrum Measurement after Laser Irradiation)

In the same manner as in Example 1, laser irradiation was performed on the aqueous potassium chloride solution-immersed film with the laser intensity changed from 0.275 mW to 27.500 mW, and the Raman spectrum of the aqueous lithium chloride solution-immersed film after laser irradiation at each laser intensity was acquired. As a result, it was found that when the laser intensity was increased, the Raman spectrum was changed at 6.875 mW, and the crystal structure was changed. In the Raman spectrum, peaks observed at Raman shifts of 153, 205, 395, 521, and 638 cm⁻¹ suggest that, after the structural change, the crystal structure is of an anatase type.

Accordingly, it is presumed that the crystal structure was transferred from the lepidocrocite type to the anatase type when irradiation was performed with the laser intensity increased to 6.875 mW or more. When the amount of halogen contained in the oxide material is large as described above, it is considered that there is instability that the crystal structure is changed by physical stimuli such as laser beam and heat, for example, and the function to be expressed is changed, so that the properties of the oxide material cannot be stably exhibited.

### Comparative Example 5

First, an aqueous lithium chloride solution-immersed film was prepared in the same manner as in Example 1.

### Preparation of Aqueous Sodium Chloride (NaCl) Solution-Immersed Film

An aqueous sodium chloride solution having a concentration of 1 M was placed in a petri dish, and an aqueous lithium chloride solution-immersed film was immersed therein for 10 minutes. Thereafter, the film was taken out from the aqueous sodium chloride solution, and the film surface was rinsed with pure water for the purpose of removing excessive sodium chloride on the film surface. The washing was repeated until the pH of the washing liquid reached 7. Thereafter, water droplets on the film surface were lightly wiped with a waste cloth to complete an aqueous sodium chloride solution-immersed film.

### Tg-Ms Measurement

The aqueous sodium chloride solution-immersed film was heated from 50° C. to 500° C. at a heating rate of 10° C./min in a He atmosphere (flow rate: 70 mL/min). The amount of crystal water calculated from the peak of H₂O gas present at the position of 300 to 500° C. at the time of temperature rise was 1.97 wt %.

### IC Measurement

First, 20 mL of pure water was put into 0.01 g of an aqueous sodium chloride solution-immersed film, and the film was shaken at 50 to 250 r/min for 60 minutes using a strong shaker (Reciprocal shaker SR-2) manufactured by TAITEC CORPORATION, then centrifuged at 2500 rpm for 10 minutes, and filtered once using a filtration filter (DISMIC13HP model number: 13HPO20CN manufactured by Advantec). The measurement of each halogen (Cl, Br, F, I, and At) in the solution (filtrate) after filtration was performed using ion chromatography (IC). As a result, the concentration of each halogen in the aqueous solution was 0.54 wt %.

### Raman Spectroscopic Measurement

A Raman spectrum was acquired under the same conditions as in Example 1. As a result, as in Example 1, peaks were observed in the Raman spectrum at Raman shifts of 198, 286, 453, 684, and 956 cm⁻¹. Accordingly, it is considered that the film produced in Comparative Example 5 also has a lepidocrocite type crystal structure. In addition, the presence of a peak at 665 to 745 cm⁻¹ and the fact that the intensity at 735 to 745 cm⁻¹ was larger than that at 745 to 765 cm⁻¹ suggest that the TMA cations and TMAH used for preparing the slurry containing TiCO were removed and substituted with sodium cations and sodium.

(Raman Spectrum Measurement after Laser Irradiation)

In the same manner as in Example 1, laser irradiation was performed on the aqueous sodium chloride solution-immersed film with the laser intensity changed from 0.275 mW to 27.500 mW, and the Raman spectrum of the aqueous lithium chloride solution-immersed film after laser irradiation at each laser intensity was acquired. As a result, it was found that when the laser intensity was increased, the Raman spectrum was changed at 6.875 mW, and the crystal structure was changed. In the Raman spectrum, peaks observed at Raman shifts of 153, 205, 395, 521, and 638 cm⁻¹ suggest that, after the structural change, the crystal structure is of an anatase type.

Accordingly, it is presumed that the crystal structure was converted from the lepidocrocite type to the anatase type when irradiation was performed with the laser intensity increased to 6.875 mW or more. When the amount of halogen contained in the oxide material is large as described above, it is considered that there is instability that the crystal structure is changed by physical stimuli such as laser beam and heat, for example, and the function to be expressed is changed, so that the properties of the oxide material cannot be stably exhibited.

### Comparative Example 6

A TiCO film in Example 1 was prepared, and Raman spectroscopic measurement was performed using a film (free-standing film) not immersed in an aqueous potassium hydroxide (KOH) solution.

### Raman Spectroscopic Measurement

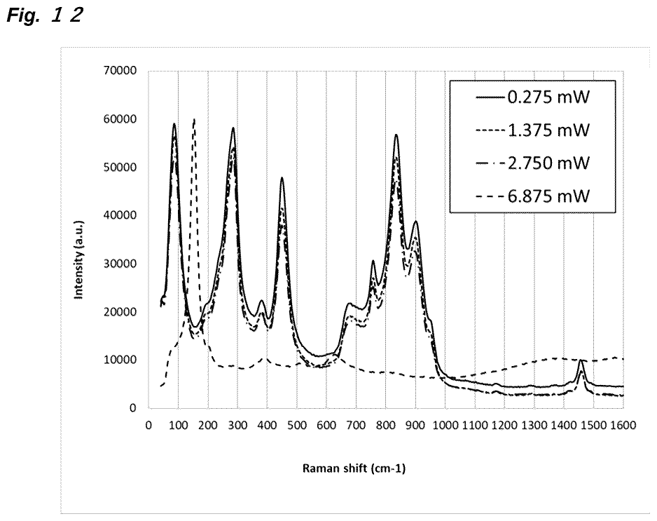

A Raman spectrum was acquired under the same conditions as in Example 1. As shown in FIG. 12, in the Raman spectrum, peaks observed at Raman shifts of 198, 286, 453, 684, and 956 cm⁻¹ suggest that the crystal structure is of the lepidocrocite type. Since a peak was observed in the vicinity of 760 cm⁻¹, it was found that TMA cations and TMAH were present in the film.

It was found that when the laser intensity was increased, the Raman spectrum was changed at 6.875 mW, and the crystal structure was changed. In the Raman spectrum, peaks observed at Raman shifts of 153, 205, 395, 521, and 638 cm⁻¹ suggest that the crystal structure is of the anatase type. From the above, it was presumed that when the laser intensity was 6.875 mW or more, the crystal structure was transferred from the lepidocrocite type to the anatase type. For example, it is considered that there is an instability that the crystal structure is changed by a physical stimulus such as laser beam or heat, and the expressed function is changed.

The oxide material of the present disclosure can be used in a wide variety of applications, for example, photocatalysts, dye decomposition, hydrogen production, batteries, supercapacitors, gas adsorbents, urea adsorbents, and ion conductors.

1. An oxide material comprising:
one or more materials selected from the group consisting of a nanofiber, a nanowire, and a two-dimensional substance, and represented by a formula:
MQₐO_{b}
wherein M is one or more element selected from the group consisting of Groups 3, 4, 5, 6, and 7,
Q is one or more element selected from the group consisting of Groups 12, 13, 14, 15, and 16, excluding O,
a is 0 to 2, and
b is more than 0 and 2 or less; and
a metal element and/or metalloid element on a surface and/or between layers of the one or more materials,
wherein a total content of halogen elements in the oxide material is 0.90 mass % or less.

2. The oxide material according to claim 1, wherein the total content of the halogen elements is 0.50 mass % or less.

3. The oxide material according to claim 1, wherein the total content of the halogen elements is 0.20 mass % or less.

4. The oxide material according to claim 1, wherein the total content of the halogen elements is 0 mass %.

5. The oxide material according to claim 1, wherein the halogen elements are one or more selected from the group consisting of Cl, Br, F, I, and At.

6. The oxide material according to claim 1, wherein a crystal structure of the oxide material is a lepidocrocite type.

7. The oxide material according to claim 1, wherein a content of crystal water in the oxide material is 10 mass % or less.

8. The oxide material according to claim 1, wherein a content of crystal water in the oxide material is 5 mass % or less.

9. The oxide material according to claim 1, wherein a content of crystal water in the oxide material is 0.001 to 10 mass %.

10. The oxide material according to claim 1, wherein the oxide material has a peak in a diffraction angle 2θ in a range of 2° to 12° in an X-ray diffraction (XRD) pattern.

11. The oxide material according to claim 1, wherein M is Ti, Q is C, and a is not 0.

12. The oxide material according to claim 1, wherein the metal element and/or the metalloid element is one or more selected from the group consisting of K, Na, Li, Ca, and Mg.

13. An ion conductor comprising:
an oxide material comprising one or more selected from the group consisting of a nanofiber, a nanowire, and a two-dimensional substance, and represented by a formula:
MQₐO_{b}
wherein M is one or more element selected from the group consisting of Groups 3, 4, 5, 6, and 7,
Q is one or more element selected from the group consisting of Groups 12, 13, 14, 15, and 16, excluding O,
a is 0 to 2, and
b is more than 0 and 2 or less; and
a metal element and/or metalloid element on a surface and/or between layers of the oxide material,
wherein a total content of halogen elements in the oxide material is 0.90 mass % or less, a crystal structure of the oxide material is a lepidocrocite type, a content of crystal water in the oxide material is 10 mass % or less, and the metal element and/or the metalloid element in the oxide material is one or more selected from the group consisting of K, Na, Li, Ca, and Mg.

14. The oxide material according to claim 13, wherein the total content of the halogen elements is 0.50 mass % or less.

15. The oxide material according to claim 13, wherein the total content of the halogen elements is 0.20 mass % or less.

16. The oxide material according to claim 13, wherein the total content of the halogen elements is 0 mass %.

17. The oxide material according to claim 13, wherein the halogen elements are one or more selected from the group consisting of Cl, Br, F, I, and At.

18. The oxide material according to claim 13, wherein a content of crystal water in the oxide material is 0.001 to 10 mass %.

19. The oxide material according to claim 13, wherein the oxide material has a peak in a diffraction angle 2θ in a range of 2° to 12° in an X-ray diffraction (XRD) pattern.

20. The oxide material according to claim 13, wherein M is Ti, Q is C, and a is not 0.
